(19) United States
(12) Patent Application Publication
(10) Pub. No.: US 2011/0081087 A1
(43) Pub. Date: Apr. 7, 2011

(54) Fast Hysteresis Thresholding in Canny Edge Detection

(76) Inventor: Darnell J. Moore, Richardson, TX (US)

(21) Appl. No.: 12/572,704

(22) Filed: Oct. 2, 2009

(51) Int. Cl. G06K 9/48

(52) U.S. Cl. 382/199

(57) ABSTRACT

A method of image processing is provided which includes non-recursive hysteresis thresholding in Canny edge detection. The non-recursive hysteresis thresholding reduces computational complexity and eliminates the potential for call stack overflow. More specifically, hysteresis thresholding is performed in a raster-scan order pass over the image data to connect edge segments to form continuous edges.

### BACKGROUND OF THE INVENTION

Image processing systems are used in a wide variety of applications. For example, in video and still digital cameras, image processing is used to enhance picture quality by filtering out noise and other artifacts. In medical imaging, image processing systems are used to detect organ abnormalities, masses, and other physiological irregularities. In vehicle navigation systems, image processing systems are used to detect lane markings, approaching vehicles, etc. In security and surveillance systems, image processing systems are used to detect changes in areas under surveillance.

Edge detection is a fundamental tool in image processing systems. It is often used to locate object boundaries before additional image processing steps, such as segmentation and classification, are applied. An edge is defined as a discontinuity in pixel intensity within an image. For example, in gray-scale images, an edge is an abrupt gray-level change between neighboring pixels. By highlighting the most predominant discontinuities, edge detection can reveal boundaries between regions of contrasting image intensity.

While there are many different edge detection techniques, the Canny edge detector is regarded as a near optimal edge detection technique because it produces reliable, thin edges even in the presence of noise in the image. Developed by John Canny in 1986, the multiple-stage method first smoothes an image to remove noise. The second stage applies horizontal and vertical gradient filters to identify areas in the image with high spatial derivatives. A non-maximum suppression algorithm is then applied to suppress any pixel whose gradient magnitude along the principle gradient direction is not the maximum among its neighbors. In the final stage, hysteresis thresholding applies two thresholds to the remaining pixels that have not been suppressed, i.e., possible edges. If the pixel's gradient magnitude is below the lower threshold, the pixel is set to zero, i.e., a possible edge is relabeled as a non-edge pixel. If the gradient magnitude is above the higher threshold, the pixel is marked as an edge pixel. If the magnitude of a pixel is between the two thresholds, then the pixel magnitude is set to zero unless there is a path from the corresponding pixel to a pixel with a gradient above the higher threshold.

Hysteresis thresholding is commonly implemented using a recursive function to find paths between pixels, i.e., to link pixels along the same edge. Recursive functions can cause instability, especially in resource-limited embedded systems, because each function call consumes valuable on-chip memory on the call stack. Depending on image content and the number of possible edges, the recursive edge linking approach can add many instances of itself to the call stack. Once the call stack has exhausted all available memory, application and/or processor stability can be compromised. Accordingly, improvements in Canny edge detection that reduce resource consumption are desirable for embedded image processing applications.

### BRIEF DESCRIPTION OF THE DRAWINGS

Particular embodiments in accordance with the invention will now be described, by way of example only, and with reference to the accompanying drawings:

FIG. 1 shows a block diagram of an embedded vision system in accordance with one or more embodiments of the invention;

FIG. 2 shows a flow diagram of a method for Canny edge detection in accordance with one or more embodiments of the invention;

FIGS. 3 and 4 show examples in accordance with one or more embodiments of the invention;

FIGS. 5A and 5B show flow diagrams of a method for hysteresis thresholding in accordance with one or more embodiments of the invention; and

FIGS. 6-8 show illustrative image processing digital systems in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein. Further, pseudo code expressed in the C programming language is presented for only purposes of describing embodiments of a method and should not be construed to limit the scope of the claimed invention.

In general, embodiments of the invention provide for non-recursive hysteresis thresholding in Canny edge detection that reduces computational complexity and eliminates the potential for call stack overflow. More specifically, in embodiments of the invention, hysteresis thresholding is performed in a raster-scan order pass over the image data to connect edge segments to form continuous edges.

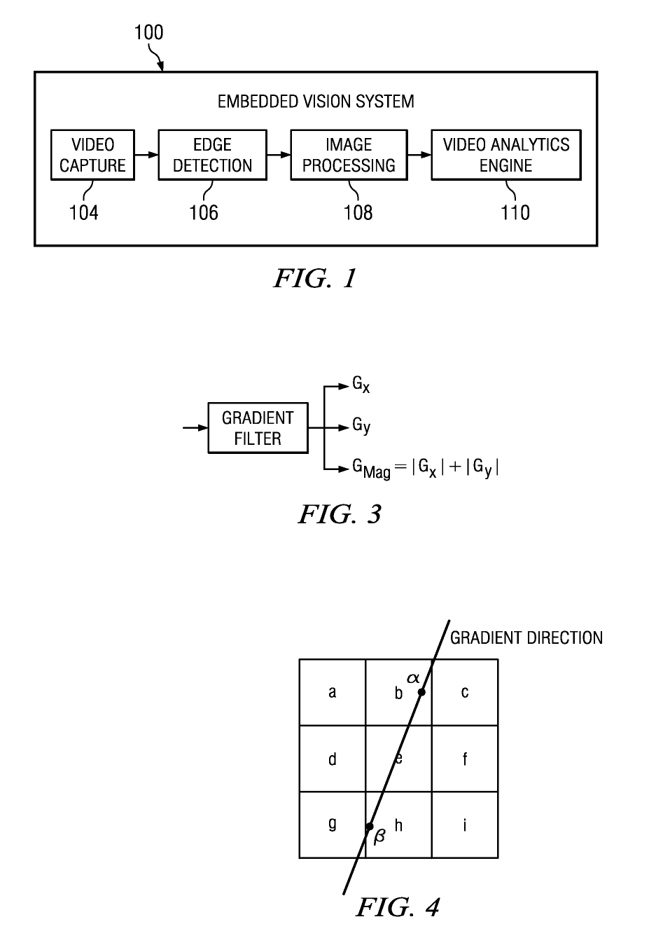

FIG. 1 shows a block diagram of an embedded vision system (100) in accordance with one or more embodiments of the invention. The system (100) includes a video capture component (104), an edge detection component (106), an image processing component (108), and a video analytics engine (110). The components in the embedded vision system may be implemented in any suitable combination of software, firmware, and hardware, such as, for example, one or more digital signal processors (DSPs), microprocessors, discrete logic, application specific integrated circuits (ASICs), etc.

The video capture component (104) is configured to provide a video sequence to be analyzed by the video analytics engine (110). The video capture component (104) may be for example, a digital video camera, a medical imaging device, a video archive, or a video feed from a video content provider. In some embodiments of the invention, the video capture component (104) may generate computer graphics as the video sequence, or a combination of live video and computer-generated video.

The edge detection component (106) receives the video sequence from the video capture component and performs a method for Canny edge detection as described herein. The image processing component (108) receives the results of the edge detection from the edge detection component (106) and uses the results to perform further processing on the video sequence. The video analytics engine (110) receives the resulting video sequence from the image processing component (108) and interprets the video content based on various object and models. In general, video analytics deploys techniques and methods commonly used in the field of computer vision to analyze and model video content for gathering high-level, qualitative information about objects, subjects and their interactions. For example, modern security cameras now embed video analytics to automatically detect specific events, e.g., motion caused by a moving person, and send alerts without human supervision. In short, Video Analytics is the science and technology that allows machines to “see.” Today, systems equipped with Video Analytics generally provide a limited set of capabilities like ‘people counting’ or ‘discovering abandoned objects’. Even for these limited tasks, Video Analytic systems can be very complex, often incorporating many smaller systems and algorithms designed to accomplish specific tasks, e.g., moving object segmentation, feature extraction, motion estimation, tracking, object classification, object recognition, learning, etc.

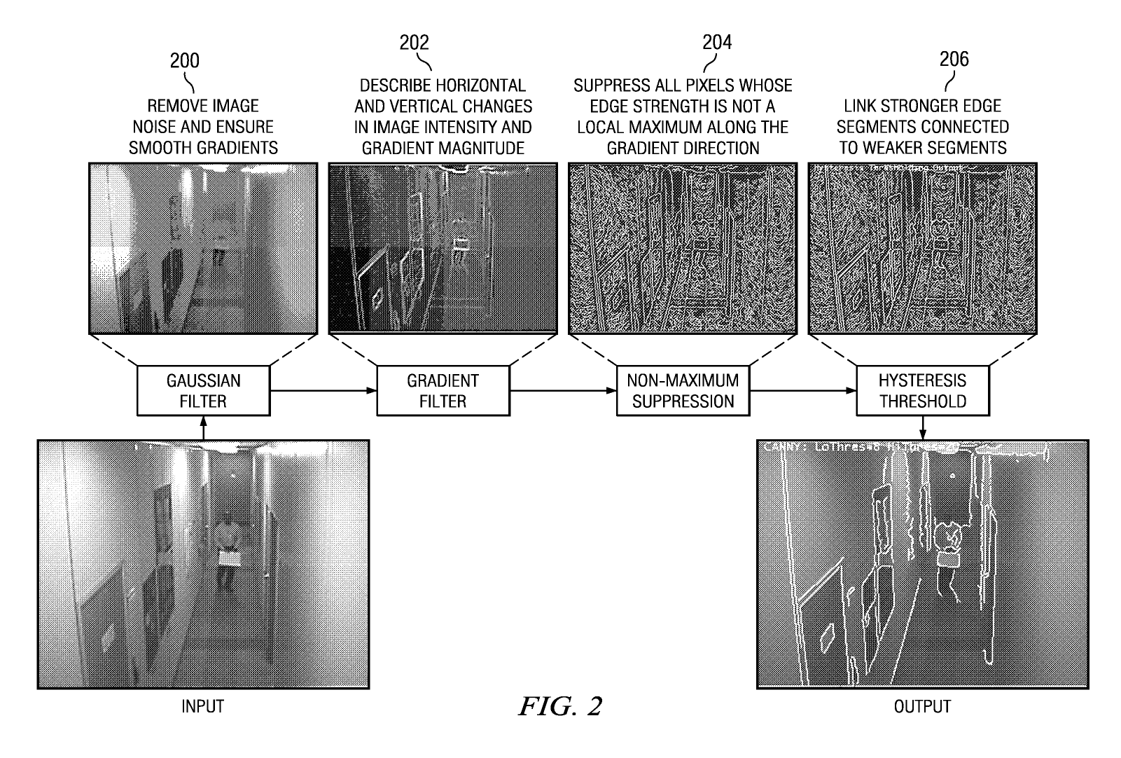

FIG. 2 shows a flow diagram of a method for Canny edge detection in a digital image in accordance with one or more embodiments of the invention. FIG. 2 also includes examples of the output of each step of the method. A digital image is a block of pixels captured by an image capture device and/or generated by a computer program. The digital image, e.g., the input image of FIG. 2, may be accessed, for example, by receiving the digital image from an image capture device or reading the digital image from a memory or storage device. The digital image may be, for example, a single image (or a subset thereof) captured by digital still image capture device or a frame (or a subset thereof) of a video sequence captured by a digital video capture device.

Initially, the digital image is processed to remove image noise and ensure smooth gradients (200). More specifically, in one or more embodiments of the invention, a Gaussian filter is applied to the digital image to remove image noise. Any suitable Gaussian filter implementation may be used. For example, in one or more embodiments of the invention, a separable, two-dimensional 5-tap filter is applied to produce a discrete approximation to a continuous 2-D Gaussian function. A pseudo-code description of an embodiment is as follows:

```
  unsigned short gaussianMask[5][5] =
{
  {1, 4, 6, 4, 1},
  {4, 16, 24, 16, 4},
  {6, 24, 36, 24, 6},
  {4, 16, 24, 16, 4},
  {1, 4, 6, 4, 1}
};
```

The 2-D filter can be applied using standard convolution methods, e.g., first convolving the image with a single dimensional 5-tap filter in the horizontal direction, then in the vertical direction.

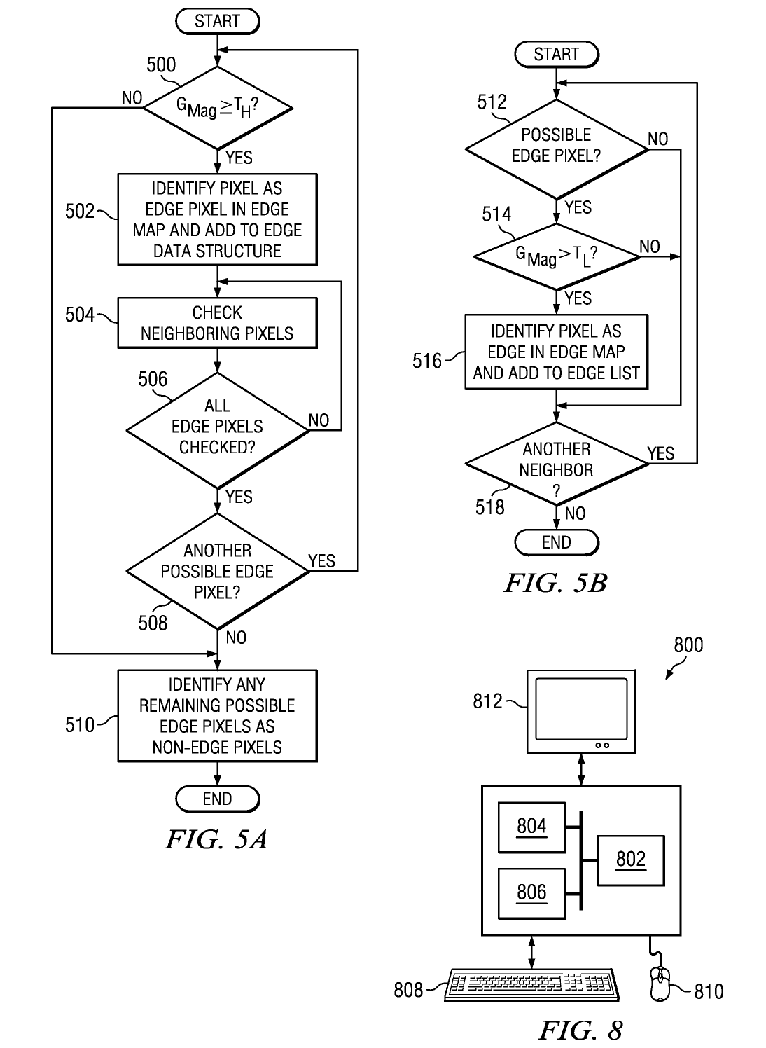

The smoothed digital image is then filtered by a 2-D gradient function to describe the spatial changes in image intensity and calculate the gradient magnitude (202). More specifically, as shown in FIG. 3, a 2-D gradient filter is applied to the smoothed digital image to measure the horizontal (Gₓ) and vertical (G_{y}) gradients at each pixel of the smoothed digital image by taking derivatives of the image, and to estimate the gradient magnitude G_{Mag} (i.e., the edge strength) at each pixel, e.g., G_{Mag}=|Gₓ|+|G_{y}|. In one or more embodiments of the invention, the horizontal gradient is taken to be the first order image derivative or Gₓ=[−1 0 1]. The vertical gradient is also defined as the first order image derivative, i.e., G_{y}=[−1 0 1]. An approximation to the true gradient magnitude, i.e., sqrt(Gₓ*Gₓ+G_{y}*G_{y}), that offers less computational complexity is given by G_{Mag}=|Gₓ|+|G_{y}|, which suffices for most embodiments.

Referring again to FIG. 2, the filtered digital image is processed to generate an edge map in which all pixels whose edge strength is not a local maximum along the gradient direction, i.e., the edge direction, are suppressed (204). More specifically, for each pixel in the filtered digital image, the gradient direction is determined using the horizontal gradient Gₓ and the vertical gradient G_{y} for the pixel as determined by the gradient filter. In one or more embodiments of the invention, gradient direction is computed as invtan(G_{y}/Gₓ). One of ordinary skill in the art will appreciate that approximating the gradient direction to the nearest 45 degree wedge suffices for a discrete spatial distribution of pixels. Once the gradient directions are known, non-maximum suppression can be performed on the filtered digital image. As shown in the example of FIG. 4, in some embodiments of the invention, a pixel e is determined to be a possible edge pixel, i.e., is not suppressed, if G_{M}(e)>G_{M}(α) and G_{M}(e)>G_{M}(β). That is, a pixel e is not suppressed if the gradient magnitude at pixel e is greater than the gradient magnitude at both α and β.

Note that α and β are interpolated locations (not necessarily at fixed discrete points) which lie along the axis defined by the principle gradient direction calculated at e. The output of the non-maximum suppression is the edge map of the digital image identifying possible edge pixels and non-edge pixels. In one or more embodiments of the invention, if a pixel is not suppressed, the value of the pixel in the edge map is set to a non-zero value, e.g., 127. Any pixel that does not meet these criteria is suppressed, i.e., the value of the pixel in the edge map is set to 0. As can be seen from the example in FIG. 2, an image after non-maxi mum suppression is made up of thin lines indicating the possible edges.

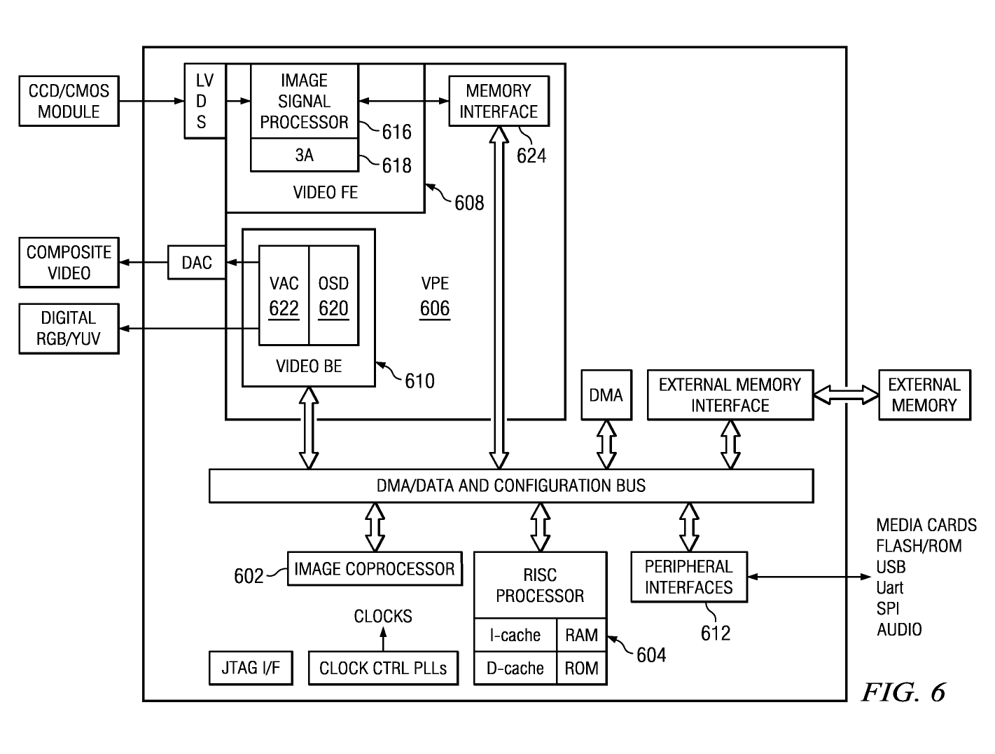

Finally, hysteresis thresholding is performed to link stronger edge segments connected to weaker edge segments to form continuous edges (206). Methods for performing hysteresis thresholding in accordance with one or more embodiments of the invention are described below in reference to FIGS. 5A and 5B and Table 1. In general, in one or more embodiments of the invention, to perform the hysteresis thresholding, two empirically determined thresholds, an upper gradient magnitude threshold and a lower gradient magnitude threshold, are used to determine if a pixel in the edge map is an edge pixel, not an edge pixel, or is possibly an edge pixel. If the magnitude of the gradient (G_{Mag}) of a pixel identified as a possible edge pixel is equal to or lower than the lower gradient magnitude threshold, the pixel is identified as a non-edge pixel in the edge map, e.g., the value of the pixel in the edge map is set to zero.

If the magnitude of the gradient of the pixel is equal to or above the upper gradient magnitude threshold, the pixel is identified as an edge pixel in the edge map, e.g., the value of the pixel in the edge map is set to 255. If the magnitude of the gradient of the pixel is between the two thresholds, the pixel is identified as an edge pixel if the pixel is connected to an edge pixel, i.e., is an immediate neighbor of an edge pixel. The immediate neighbors of a pixel are the eight pixels surrounding the pixel above, below and to the left and right of the pixel. For example, in FIG. 4, the immediate neighbors of pixel e are pixels a, b, c, d, f, g, h, and i. At the end of the hysteresis thresholding, any pixel in the edge map that is still identified as a possible edge pixel is identified as a non-edge pixel.

FIGS. 5A and 5B are flow diagrams of a method for hysteresis thresholding in accordance with one or more embodiments of the invention. As previously mentioned, hysteresis thresholding using an upper gradient magnitude threshold, referred to as T_{H} herein, and a lower gradient magnitude threshold, referred to as T_{L} herein, is applied to an edge map to form continuous edges. In one or more embodiments of the invention, the values of T_{H} and T_{L} are empirically determined. For example, in 8-bit grayscale images, appropriate values for T_{H} and T_{L} are influenced by the image content, noise, etc. and generally range between 10 and 100 with an offset of roughly 10 to 50 points between them. The edge map prior to applying hysteresis thresholding is a representation of a digital image in which each location indicates whether a corresponding pixel in the digital image is a possible edge pixel or is a non-edge pixel. Further, all boundary pixels in the digital image are identified as non-edge pixels in the edge map.

The method begins by scanning through the edge map in raster scan order to locate the first pixel that is identified as a possible edge pixel. If the gradient magnitude of the pixel is greater than or equal to T_{H} (500), the pixel is identified as an edge pixel in the edge map and information specifying the location of the edge pixel in the edge map (e.g., a pointer, an array index, etc.) is added to an edge data structure (502). The edge data structure may be any data structure suitable for temporarily storing information specifying the locations of edge pixels in the edge map. Then, an iterative process of checking neighboring pixels of edge pixels having locations stored in the edge data structure to identify additional edge pixels is initiated (504). When the iterative process is initiated, the location of only one edge pixel is stored in the edge data structure. The locations of additional edge pixels may be added to the edge data structure by the check neighboring pixels method shown in FIG. 5B.

In the iterative process, the check neighboring pixels method (504) is performed for each edge pixel having a location stored in the edge data structure (506). As shown in FIG. 5B, the check neighboring pixels method checks each of the eight neighboring pixels of the edge pixel to identify any of the neighboring edge pixels that are identified as possible edge pixels as edge pixels if their gradient magnitudes are above T_{L}. More specifically, if a neighboring pixel is identified as a possible edge pixel (512) and the gradient magnitude of the neighboring pixel is above T_{L} (514), the neighboring pixel is identified as an edge pixel in the edge map and information identifying the location of the pixel is added to the edge data structure (516). Otherwise, the next neighboring pixel, if any (518), is checked. The method terminates when all eight neighboring pixels have been checked.

After all edge pixels in the edge data structure have been checked (506), or if gradient magnitude of the previously located pixel was less than T_{H} (500), the raster order scan of the edge map is resumed to locate the next pixel in the edge map that is identified as a possible edge pixel. If such a pixel is found before reaching the end of the edge map (508), the method performs another loop (500). Otherwise, any pixels in the edge map that are still identified as possible edge pixels are identified as non-edge pixels (510) and the method terminates.

Table 1 is a pseudo code listing showing a method of hysteresis thresholding in accordance with one or more embodiments. The pseudo code is expressed in the C programming language for ease of understanding and is not intended to be construed as an executable program. Comments are provided in the pseudo code to explain the method. The pseudo code assumes the existence of an edge map for a block of pixels that is represented as a two-dimensional array (pEdgeMap) of the same size as the block of pixels. Initially, in this edge map, a location corresponding to a non-edge pixel in the block of pixels has a value of zero and a location corresponding to a possible edge pixel has a value of 127. Further, all locations corresponding to boundary pixels are set to a value of zero. The pseudo code also assumes the existence of a two-dimensional array (pEdgeMag) of the same size as the block of pixels and storing pre-computed gradient magnitudes for each of the pixels in corresponding locations. In addition, the pseudo code assumes the existence of an upper gradient maximum threshold (hiThreshold) and a lower gradient maximum threshold (loThreshold).

Embodiments of the methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium and loaded and executed in the processor. In some cases, the software may also be sold in a computer program product, which includes the computer-readable medium and packaging materials for the computer-readable medium.

Embodiments of the methods for performing edge detection as described herein may be implemented for virtually any type of digital system (e.g., a desk top computer, a laptop computer, a medical imaging system, a video surveillance system, a vehicle navigation system, a handheld device such as a mobile (i.e., cellular) phone, a personal digital assistant, a digital camera, etc.) with functionality to perform image processing. FIGS. 14-16 show block diagrams of illustrative digital systems.

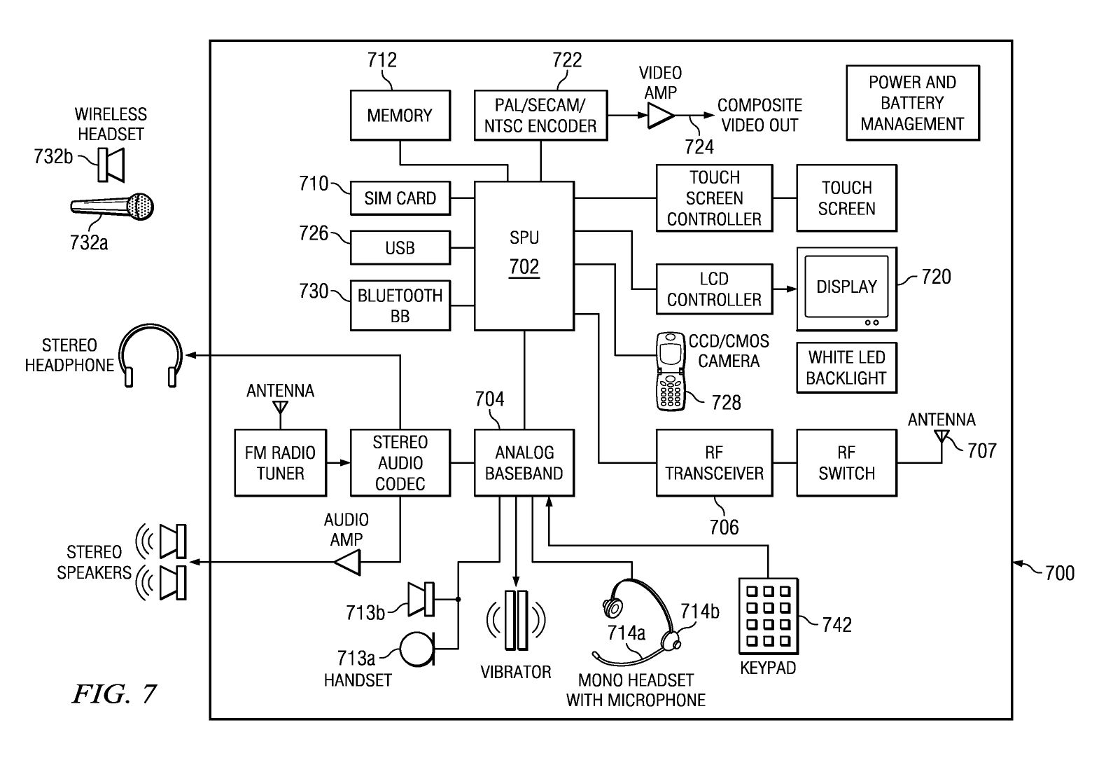

FIG. 6 shows a digital system suitable for an embedded system (e.g., a digital camera) in accordance with one or more embodiments of the invention that includes, among other components, a DSP-based image coprocessor (ICP) (602), a RISC processor (604), and a video processing engine (VPE) (606) that may be configured to perform the bit-rate estimation method and/or the rate-distortion cost estimation method described herein. The RISC processor (604) may be any suitably configured RISC processor. The VPE (606) includes a configurable video processing front-end (Video FE) (608) input interface used for video capture from imaging peripherals such as image sensors, video decoders, etc., a configurable video processing back-end (Video BE) (610) output interface used for display devices such as SDTV displays, digital LCD panels, HDTV video encoders, etc, and memory interface (624) shared by the Video FE (608) and the Video BE (610). The digital system also includes peripheral interfaces (612) for various peripherals that may include a multi-media card, an audio serial port, a Universal Serial Bus (USB) controller, a serial port interface, etc.

The Video FE (608) includes an image signal processor (ISP) (616), and a 3A statistic generator (3A) (618). The ISP (616) provides an interface to image sensors and digital video sources. More specifically, the ISP (616) may accept raw image/video data from a sensor (CMOS or CCD) and can accept YUV video data in numerous formats. The ISP (616) also includes a parameterized image processing module with functionality to generate image data in a color format (e.g., RGB) from raw CCD/CMOS data. The ISP (616) is customizable for each sensor type and supports video frame rates for preview displays of captured digital images and for video recording modes. The ISP (616) also includes, among other functionality, an image resizer, statistics collection functionality, and a boundary signal calculator. The 3A module (618) includes functionality to support control loops for auto focus, auto white balance, and auto exposure by collecting metrics on the raw image data from the ISP (616) or external memory. In one or more embodiments of the invention, the Video FE (608) is configured to perform a method for edge detection as described herein.

The Video BE (610) includes an on-screen display engine (OSD) (620) and a video analog encoder (VAC) (622). The OSD engine (620) includes functionality to manage display data in various formats for several different types of hardware display windows and it also handles gathering and blending of video data and display/bitmap data into a single display window before providing the data to the VAC (622) in YCbCr format. The VAC (622) includes functionality to take the display frame from the OSD engine (620) and format it into the desired output format and output signals required to interface to display devices. The VAC (622) may interface to composite NTSC/PAL video devices, S-Video devices, digital LCD devices, high-definition video encoders, DVI/HDMI devices, etc.

The memory interface (624) functions as the primary source and sink to modules in the Video FE (608) and the Video BE (610) that are requesting and/or transferring data to/from external memory. The memory interface (624) includes read and write buffers and arbitration logic.

The ICP (602) includes functionality to perform the computational operations required for compression and other processing of captured images. The video compression standards supported may include one or more of the JPEG standards, the MPEG standards, and the H.26x standards. In one or more embodiments of the invention, the ICP (602) is configured to perform the computational operations of a method for edge detection as described herein.

In operation, to capture an image or video sequence, video signals are received by the video FE (608) and converted to the input format needed to perform video compression. Prior to the compression, a method for edge detection as described herein may be applied as part of processing the captured video data. The video data generated by the video FE (608) is stored in the external memory. The video data is then encoded, i.e., compressed. During the compression process, the video data is read from the external memory and the compression computations on this video data are performed by the ICP (602). The resulting compressed video data is stored in the external memory. The compressed video data may then read from the external memory, decoded, and post-processed by the video BE (610) to display the image/video sequence.

FIG. 7 is a block diagram of a digital system (e.g., a mobile cellular telephone) (700) that may be configured to perform a method for edge detection as described herein. The signal processing unit (SPU) (702) includes a digital processing processor system (DSP) that includes embedded memory and security features. The analog baseband unit (704) receives a voice data stream from handset microphone (713a) and sends a voice data stream to the handset mono speaker (713b). The analog baseband unit (704) also receives a voice data stream from the microphone (714a) and sends a voice data stream to the mono headset (714b). The analog baseband unit (704) and the SPU (702) may be separate ICs. In many embodiments, the analog baseband unit (704) does not embed a programmable processor core, but performs processing based on configuration of audio paths, filters, gains, etc being setup by software running on the SPU (702). In some embodiments, the analog baseband processing is performed on the same processor and can send information to it for interaction with a user of the digital system (700) during a call processing or other processing.

The display (720) may also display pictures and video streams received from the network, from a local camera (728), or from other sources such as the USB (726) or the memory (712). The SPU (702) may also send a video stream to the display (720) that is received from various sources such as the cellular network via the RF transceiver (706) or the camera (726). The SPU (702) may also send a video stream to an external video display unit via the encoder (722) over a composite output terminal (724). The encoder unit (722) may provide encoding according to PAL/SECAM/NTSC video standards.

The SPU (702) includes functionality to perform the computational operations required for processing of digital images, video compression and decompression. The video compression standards supported may include, for example, one or more of the JPEG standards, the MPEG standards, and the H.26x standards. In one or more embodiments of the invention, the SPU (702) is configured to perform the computational operations of a method for edge detection as described herein. Software instructions implementing the method may be stored in the memory (712) and executed by the SPU (702) during image processing of a picture or video stream.

FIG. 8 shows a digital system (800) (e.g., a personal computer) that includes a processor (802), associated memory (804), a storage device (806), and numerous other elements and functionalities typical of digital systems (not shown). In one or more embodiments of the invention, a digital system may include multiple processors and/or one or more of the processors may be digital signal processors. The digital system (800) may also include input means, such as a keyboard (808) and a mouse (810) (or other cursor control device), and output means, such as a monitor (812) (or other display device). The digital system (800) may also include an image capture device (not shown) that includes circuitry (e.g., optics, a sensor, readout electronics) for capturing video sequences. The digital system (800) may be connected to a network (814) (e.g., a local area network (LAN), a wide area network (WAN) such as the Internet, a cellular network, any other similar type of network and/or any combination thereof) via a network interface connection (not shown). The digital system (800) may receive digital video sequences and/or digital pictures via the network, via the image capture device, and/or via a removable storage medium (e.g., a floppy disk, optical disk, flash memory, USB key, a secure digital storage card, etc.) (not shown), and process the digital video/pictures using image processing software that includes a method for edge detection as described herein. Those skilled in the art will appreciate that these input and output means may take other forms.

Further, those skilled in the art will appreciate that one or more elements of the aforementioned digital system (800) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, or any other computer readable storage device. The software instructions may be distributed to the digital system (800) via removable memory (e.g., floppy disk, optical disk, flash memory, USB key), via a transmission path from a computer readable medium on another digital system, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

It is therefore contemplated that the appended claims will cover any such modifications of the embodiments as fall within the true scope and spirit of the invention.

TABLE 1
Hysteresis Pseudo Code

| | |
|---|---|
| 1 | #define EDGE 255 |
| 2 | #define POSSIBLE_EDGE 127 |
| 3 | #define NON_EDGE 0 |
| 4 | |
| 5 | void FastHysteresis(unsigned short *pEdgeMag, |
| 6 | unsigned char *pEdgeMap, |
| 7 | int *edgeList, |
| 8 | unsigned short blkHeight, |
| 9 | unsigned short blkWidth, |
| 10 | unsigned short hiThreshold, |
| 11 | unsigned short loThreshold) |
| 12 | { |
| 13 | int y; |
| 14 | int x; |
| 15 | int pos; |
| 16 | int checkLocation; |
| 17 | int offset[8]; |
| 18 | int numItems = 0; |
| 19 | |
| 20 | // offsets that allow indexing to the 8 surrounding neighbors; set up once and used |
| 21 | // as required |
| 22 | offset[0] = − 1 − blkWidth; |
| 23 | offset[1] = − 0 − blkWidth; |
| 24 | offset[2] = + 1 − blkWidth; |
| 25 | offset[3] = + 1; |
| 26 | offset[4] = + 1 + blkWidth; |
| 27 | offset[5] = − 0 + blkWidth; |
| 28 | offset[6] = − 1 + blkWidth; |
| 29 | offset[7] = − 1; |
| 30 | |
| 31 | // Scan through the edge map in raster-scan order (top to bottom, left to right) |
| 32 | // To handle boundary conditions, edge map locations along the boundary are |
| 33 | // avoided, which can't produce legitimate results since they don't have neighbors. |
| 34 | // As a pre-processing step, all boundary locations in the edge map have been |
| 35 | // labeled as NON_EDGES |
| 36 | for (y=1,pos=blkWidth+1; y <blkHeight−1; y++) |
| 37 | { |
| 38 | for (x=1; x < blkWidth−1; x++,pos++) |
| 39 | { |
| 40 | // For each element in the edge map, check to determine if there is a |
| 41 | // “possible edge” with a magnitude at or above the upper gradient magnitude |
| 42 | // threshold. This presents a reliable edge candidate. |
| 43 | if ((pEdgeMap[pos] == POSSIBLE_EDGE) && (pEdgeMag[pos] >= hiThreshold)) |
| 44 | { |
| 45 | // Given a reliable edge candidate, re-label the element in the edge map |
| 46 | // as an “edge”, then iteratively check this new edge's neighbors. The |
| 47 | // iteration count is defined by numItems and the seed position by |
| 48 | // checkLocation. |
| 49 | pEdgeMap[pos] = EDGE; |
| 50 | checkLocation = pos; |
| 51 | edgeList[numItems++] = pos; |
| 52 | while (numItems) |
| 53 | { |
| 54 | CheckNeighbors_NonRecursive(pEdgeMap, pEdgeMag, checkLocation, |
| | edgeList, &numItems, offset, loThreshold); |
| 55 | // update the next seed location with the last element in the array stack |
| 56 | checkLocation = edgeList[numItems − 1]; |
| 57 | } |
| 58 | } |
| 59 | } |
| 60 | pos += 2; |
| 61 | } |
| 62 | |
| 63 | |
| 64 | ///////////////////////////////////////////////////////////////////////////// |
| 65 | // Set all the remaining POSSIBLE_EDGEs to NON_EDGES |
| 66 | ///////////////////////////////////////////////////////////////////////////// |
| 67 | for (y=0,pos=0; y < blkHeight; y++) |
| 68 | { |
| 69 | for (x=0; x < blkWidth; x++,pos++) |
| 70 | if(pOutBlk[pos] != EDGE) |
| 71 | pOutBlk[pos] = NON_EDGE; |
| 72 | } |
| 73 | } |
| 74 | |
| 75 | where |
| 76 | |
| 77 | +----+----+----+ |
| 78 | \| TL \| TC \| TR \| |
| 79 | +----+----+----+ |
| 80 | \| LC \| C \| RC \| |
| 81 | +----+----+----+ |
| 82 | \| BL \| BC \| BR \| |
| 83 | +----+----+----+ |
| 84 | |
| 85 | void CheckNeighbors_NonRecursive(unsigned char *edgeMap, |
| 86 | unsigned short *gradientMagnitudes, |
| 87 | const int pos, |
| 88 | int *edgeList, |
| 89 | int *numItems, |
| 90 | const int *offset, |
| 91 | unsigned short loThreshold) |
| 92 | { |
| 93 | unsigned short *magTL; |
| 94 | unsigned short *magTC; |
| 95 | unsigned short *magTR; |
| 96 | unsigned short *magLC; |
| 97 | unsigned short *magRC; |
| 98 | unsigned short *magBL; |
| 99 | unsigned short *magBC; |
| 100 | unsigned short *magBR; |
| 101 | |
| 102 | unsigned char *mapTL; |
| 103 | unsigned char *mapTC; |
| 104 | unsigned char *mapTR; |
| 105 | unsigned char *mapLC; |
| 106 | unsigned char *mapRC; |
| 107 | unsigned char *mapBL; |
| 108 | unsigned char *mapBC; |
| 109 | unsigned char *mapBR; |
| 110 | |
| 111 | int addTL; |
| 112 | int addTC; |
| 113 | int addTR; |
| 114 | int addLC; |
| 115 | int addRC; |
| 116 | int addBL; |
| 117 | int addBC; |
| 118 | int addBR; |
| 119 | |
| 120 | unsigned char *mapC = edgeMap + pos; |
| 121 | unsigned short *magC = gradientMagnitudes + pos; |
| 122 | // Remove position from edgeList |
| 123 | (*numItems)--; |
| 124 | |
| 125 | // neighboring magnitude values |
| 126 | magTL = magC + offset[0]; |
| 127 | magTC = magC + offset[1]; |
| 128 | magTR = magC + offset[2]; |
| 129 | magRC = magC + offset[3]; |
| 130 | magBR = magC + offset[4]; |
| 131 | magBC = magC + offset[5]; |
| 132 | magBL = magC + offset[6]; |
| 133 | magLC = magC + offset[7]; |
| 134 | |
| 135 | // neighboring edge map state |
| 136 | mapTL = mapC + offset[0]; |
| 137 | mapTC = mapC + offset[1]; |
| 138 | mapTR = mapC + offset[2]; |
| 139 | mapRC = mapC + offset[3]; |
| 140 | mapBR = mapC + offset[4]; |
| 141 | mapBC = mapC + offset[5]; |
| 142 | mapBL = mapC + offset[6]; |
| 143 | mapLC = mapC + offset[7]; |
| 144 | |
| 145 | // Add neighbor to edgeList if its gradient magnitude is above the lower threshold |
| 146 | // and it's a possible edge (gradient magnitude peaks along the gradient |
| 147 | // direction) |
| 148 | addTL = (*mapTL == POSSIBLE_EDGE) && (*magTL > loThreshold); |
| 149 | addTC = (*mapTC == POSSIBLE_EDGE) && (*magTC > loThreshold); |
| 150 | addTR = (*mapTR == POSSIBLE_EDGE) && (*magTR > loThreshold); |
| 151 | addRC = (*mapRC == POSSIBLE_EDGE) && (*magRC > loThreshold); |
| 152 | addBR = (*mapBR == POSSIBLE_EDGE) && (*magBR > loThreshold); |
| 153 | addBC = (*mapBC == POSSIBLE_EDGE) && (*magBC > loThreshold); |
| 154 | addBL = (*mapBL == POSSIBLE_EDGE) && (*magBL > loThreshold); |
| 155 | addLC = (*mapLC == POSSIBLE_EDGE) && (*magLC > loThreshold); |
| 156 | |
| 157 | // add new positions to edgelist |
| 158 | if (addTL) |
| 159 | { |
| 160 | *mapTL = EDGE; |
| 161 | edgeList[*numItems++] = pos + offset[0]; |
| 162 | } |
| 163 | if (addTC) |
| 164 | } |
| 165 | *mapTC = EDGE; |
| 166 | edgeList[*numItems++] = pos + offset[1]; |
| 167 | } |
| 168 | if (addTR) |
| 169 | { |
| 170 | *mapTR = EDGE; |
| 171 | edgeList[*numItems++] = pos + offset[2]; |
| 172 | } |
| 173 | if (addRC) |
| 174 | { |
| 175 | *mapRC = EDGE; |
| 176 | edgeList[*numItems++] = pos + offset[3]; |
| 177 | } |
| 178 | if (addBR) |
| 179 | { |
| 180 | *mapBR = EDGE; |
| 181 | edgeList[*numItems++] = pos + offset[4]; |
| 182 | } |
| 183 | if (addBC) |
| 184 | { |
| 185 | *mapBC = EDGE; |
| 186 | edgeList[*numItems++] = pos + offset[5]; |
| 187 | } |
| 188 | if (addBL) |
| 189 | { |
| 190 | *mapBL = EDGE; |
| 191 | edgeList[*numItems++] = pos + offset[6]; |
| 192 | } |
| 193 | if (addLC) |
| 194 | { |
| 195 | *mapLC = EDGE; |
| 196 | edgeList[*numItems++] = pos + offset[7]; |
| 197 | } |
| 198 | } |

What is claimed is:

1. A method of image processing comprising:
generating an edge map of a block of pixels, wherein each pixel is identified as a non-edge pixel or a possible edge pixel; and
performing hysteresis thresholding on the edge map to identify edge pixels using an upper gradient magnitude threshold and a lower gradient magnitude threshold, wherein the hysteresis thresholding comprises:
identifying a pixel as an edge pixel and adding a location of the pixel in the edge map to an edge data structure when a gradient magnitude of the pixel is above the upper gradient magnitude threshold and the pixel is identified as a possible edge pixel in the edge map, wherein the edge data structure stores locations of edge pixels to be checked for connection to possible edge pixels; and
identifying edge pixels connected to the pixel by
selecting an edge pixel from the edge data structure,
identifying a neighboring pixel of the selected edge pixel as an edge pixel and adding a location of the neighboring pixel in the edge map to the edge data structure when a gradient magnitude of the neighboring pixel is greater than the lower gradient threshold and the neighboring pixel is identified as a possible edge pixel in the edge map, and
repeating selecting an edge pixel and identifying a neighboring pixel until all edge pixels in the edge data structure have been selected.

2. The method of claim 1, further comprising:
identifying all pixels in the edge map that are identified as possible edge pixels as non-edge pixels after hysteresis thresholding.

3. The method of claim 1, further comprising:
identifying boundary pixels in the block of pixels as non-edge pixels.

4. The method of claim 1, wherein identifying a pixel further comprises:
identifying the pixel as an edge pixel and adding the location of the pixel to the edge data structure when the gradient magnitude of the pixel is equal to the upper gradient magnitude threshold.

5. The method of claim 1, wherein identifying a neighboring pixel further comprises:
identifying the neighboring pixel as an edge pixel and adding the location of the neighboring pixel to the edge data structure when the gradient magnitude of the neighboring pixel is equal to the lower gradient threshold.

6. The method of claim 1, wherein selecting an edge pixel comprises:
removing the selected edge pixel from the edge data structure.

7. The method of claim 1, further comprising:
applying a Gaussian filter to the block of pixels to remove noise;
applying a gradient filter to the filtered block of pixels to measure horizontal and vertical gradients at each pixel and to estimate a gradient magnitude for each pixel based on the horizontal gradient and vertical gradient of the pixel; and
generating the edge map by performing non-maximum suppression on the filtered block of pixels using the horizontal and vertical gradients and the gradient magnitudes.

8. A digital image processing system comprising:
a memory configured to store an edge map of a block of pixels, wherein each pixel is identified as a non-edge pixel or a possible edge pixel and an edge data structure for storing locations of edge pixels to be checked for connection to possible edge pixels; and
an edge detection component configured to
generate the edge map; and
perform hysteresis thresholding on the edge map to identify edge pixels using an upper gradient magnitude threshold and a lower gradient magnitude threshold, wherein the hysteresis thresholding comprises:
identifying a pixel as an edge pixel and adding a location of the pixel in the edge map to the edge data structure when a gradient magnitude of the pixel is above the upper gradient magnitude threshold and the pixel is identified as a possible edge pixel in the edge map; and
identifying edge pixels connected to the pixel by
selecting a location of an edge pixel from the edge data structure,
identifying a neighboring pixel of the selected edge pixel as an edge pixel and adding a location of the neighboring pixel in the edge map to the edge data structure when a gradient magnitude of the neighboring pixel is greater than the lower gradient threshold and the neighboring pixel is identified as a possible edge pixel in the edge map, and
repeating selecting a location of an edge pixel and identifying a neighboring pixel until all edge pixels in the edge data structure have been selected.

9. The digital image processing system of claim 8, wherein the edge detection component is further configured to:
identify all pixels in the edge map that are identified as possible edge pixels as non-edge pixels after hysteresis thresholding.

10. The digital image processing system of claim 8, wherein the edge detection component is further configured to:
identifying boundary pixels in the block of pixels as non-edge pixels.

11. The digital image processing system of claim 8, wherein identifying a pixel comprises:
identifying the pixel as an edge pixel and adding the location of the pixel to the edge data structure when the gradient magnitude of the pixel is equal to the upper gradient magnitude threshold.

12. The digital image processing system of claim 8, wherein identifying a neighboring pixel further comprises:
identifying the neighboring pixel as an edge pixel and adding the location of the neighboring pixel to the edge data structure when the gradient magnitude of the neighboring pixel is equal to the lower gradient threshold.

13. The digital image processing system of claim 8, wherein selecting an edge pixel comprises:
removing the selected edge pixel from the edge data structure.

14. The digital image processing system of claim 8, wherein the edge detection component is further configured to:
apply a Gaussian filter to the block of pixels to remove noise;
apply a gradient filter to the filtered block of pixels to measure horizontal and vertical gradients at each pixel and to estimate a gradient magnitude for each pixel based on the horizontal gradient and vertical gradient of the pixel; and
generate the edge map by performing non-maximum suppression on the filtered block of pixels using the horizontal and vertical gradients and the gradient magnitudes.

15. A computer readable medium comprising executable instructions to cause a digital system to perform a method of image processing, the method comprising:
generating an edge map of a block of pixels, wherein each pixel is identified as a non-edge pixel or a possible edge pixel; and
performing hysteresis thresholding on the edge map to identify edge pixels using an upper gradient magnitude threshold and a lower gradient magnitude threshold, wherein the hysteresis thresholding comprises:
identifying a pixel as an edge pixel and adding a location of the pixel in the edge map to an edge data structure when a gradient magnitude of the pixel is above the upper gradient magnitude threshold and the pixel is identified as a possible edge pixel in the edge map, wherein the edge data structure stores locations of edge pixels to be checked for connection to possible edge pixels; and
identifying edge pixels connected to the pixel by
selecting a location of an edge pixel from the edge data structure,
identifying a neighboring pixel of the selected edge pixel as an edge pixel and adding a location of the neighboring pixel in the edge map to the edge data structure when a gradient magnitude of the neighboring pixel is greater than the lower gradient threshold and the neighboring pixel is identified as a possible edge pixel in the edge map, and
repeating selecting a location of an edge pixel and identifying a neighboring pixel until all locations of edge pixels in the edge data structure have been selected.

16. The computer readable medium comprising of claim 15, wherein the method further comprises:
identifying all pixels in the edge map that are identified as possible edge pixels as non-edge pixels after hysteresis thresholding.

17. The computer readable medium comprising of claim 15, wherein the method further comprises:
identifying boundary pixels in the block of pixels as non-edge pixels.

18. The computer readable medium comprising of claim 15, wherein identifying a pixel further comprises:
identifying the pixel as an edge pixel and adding the location of the pixel to the edge data structure when the gradient magnitude of the pixel is equal to the upper gradient magnitude threshold.

19. The computer readable medium comprising of claim 15, wherein identifying a neighboring pixel further comprises:
identifying the neighboring pixel as an edge pixel and adding the location of the neighboring pixel to the edge data structure when the gradient magnitude of the neighboring pixel is equal to the lower gradient threshold.

20. The computer readable medium comprising of claim 15, wherein the method further comprises:
applying a Gaussian filter to the block of pixels to remove noise;
applying a gradient filter to the filtered block of pixels to measure horizontal and vertical gradients at each pixel and to estimate a gradient magnitude for each pixel based on the horizontal gradient and vertical gradient of the pixel; and
generating the edge map by performing non-maximum suppression on the filtered block of pixels using the horizontal and vertical gradients and the gradient magnitudes.
